(19) United States
(12) Patent Application Publication
(10) Pub. No.: US 2026/0012981 A1
(43) Pub. Date: Jan. 8, 2026

(54) METHOD AND DEVICE FOR UPLINK TRANSMISSION AND RECEPTION IN WIRELESS COMMUNICATION SYSTEM

(71) Applicant: LG ELECTRONICS INC., Seoul (KR)

(72) Inventors: Seokmin SHIN, Seoul (KR); Hyunsoo KO, Seoul (KR); Jaehyung KIM, Seoul (KR); Suckchel YANG, Seoul (KR); Seonwook KIM, Seoul (KR); Haewook PARK, Seoul (KR)

(21) Appl. No.: 18/993,907

(22) PCT Filed: Jun. 30, 2023
(86) PCT No.: PCT/KR2023/009210

§ 371 Date: Jan. 13, 2025

(30) Foreign Application Priority Data
Jul. 15, 2022 (KR) 10-2022-0087745

(51) Int. Cl. H04W 74/0833; H04B 17/309; H04W 8/22; H04W 52/36

(52) U.S. Cl. CPC H04W 74/0833; H04B 17/346; H04W 8/22; H04W 52/36

(57) ABSTRACT

Disclosed are a method and a device for uplink transmission and reception in a wireless communication system. A method performed by a wireless communication system according to an embodiment of the present disclosure may comprise the steps of: receiving, from a base station, first configuration information related to physical random-access channel (PRACH) preamble repeated transmission; and performing first PRACH preamble repeated transmission in first multiple random-access channel occasions (ROs) one basis of the first configuration information, wherein a power of the first PRACH preamble repeated transmission performed across the first multiple ROs is based on a first reference signal (RS) for acquiring of a path-loss value, and transmission power ramping is not be applied within the first multiple ROs.

### CROSS-REFERENCE TO RELATED APPLICATIONS

This application is a National Stage application under 35 U.S.C. § 371 of International Application No. PCT/KR2023/009210, filed on Jun. 30, 2023, which claims the benefit of earlier filing date and right of priority to KR Application No. 10-2022-0087745, filed on Jul. 15, 2022, the contents of which are all hereby incorporated by reference herein in their entirety.

### TECHNICAL FIELD

The present disclosure relates to a wireless communication system, and more specifically to a method and device for performing uplink transmission and reception in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

The technical problem of the present disclosure is to provide a method and device for performing uplink transmission and reception in a wireless communication system.

In addition, an additional technical problem of the present disclosure is to provide a method and device for performing beam operation and power control for repeated transmission of a PRACH preamble.

In addition, an additional technical problem of the present disclosure is to provide a method and device for setting a reference signal for calculating path-loss during repeated transmission of a PRACH preamble.

The technical objects to be achieved by the present disclosure are not limited to the above-described technical objects, and other technical objects which are not described herein will be clearly understood by those skilled in the pertinent art from the following description.

According to one embodiment of the present disclosure, a method performed by a user equipment (UE) in a wireless communication system may include: receiving first configuration information related to repeated transmission of a physical random access channel (PRACH) preamble from a base station; and performing repeated transmission of a first PRACH preamble in a first plurality of RO (radon access channel occasions) based on the first configuration information, and a power of the repeated transmission of the first PRACH preamble performed across the first plurality of ROs may be based on a first reference signal (RS) for obtaining a path-loss value, and transmission power ramping may be not applied within the first plurality of ROs.

According to one embodiment of the present disclosure, a method performed by a base station in a wireless communication system may include transmitting first configuration information related to repeated transmission of a physical random access channel (PRACH) preamble to a user equipment (UE); and performing repeated reception of a first PRACH preamble in a first plurality of RO (radon access channel occasions) based on the first configuration information, and a power of the repeated transmission of the first PRACH preamble performed across the first plurality of ROs may be based on a first reference signal (RS) for obtaining a path-loss value, and transmission power ramping may be not applied within the first plurality of ROs.

According to an embodiment of the present disclosure, a method and device for performing uplink transmission and reception in a wireless communication system may be provided.

In addition, according to various embodiments of the present disclosure, a method and device for performing beam operation and power control for PRACH preamble repetition transmission may be provided.

In addition, according to various embodiments of the present disclosure, a method and device for configuring a reference signal for calculating path-loss during PRACH preamble repetition transmission may be provided.

In addition, according to various embodiments of the present disclosure, a transmission power may be set not to change while performing PRACH preamble repetition transmission.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 illustrates an example of a wireless communication system supporting an unlicensed band applicable to the present disclosure.

FIG. 8 is a diagram illustrating an uplink transmission and reception operation in a wireless communication system to which the present disclosure may be applied.

FIG. 9 is a diagram for explaining an uplink transmission operation of a UE in a wireless communication system to which the present disclosure may be applied.

FIG. 10 is a diagram for describing an uplink reception operation of a base station in a wireless communication system to which the present disclosure may be applied.

FIG. 11 is a diagram for describing an operation of a terminal selecting RO(s) for repeated transmission of a PRACH preamble according to an embodiment of the present disclosure.

FIG. 12 is a diagram for describing a signaling procedure of a network side and a UE according to an embodiment of the present disclosure.

FIG. 13 is an exemplary block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes wireless a communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx

Release 8. In detail, an LTE technology 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36. 211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and

NG-RAN (New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block

(including PSS (primary synchronization signal), SSS (secondary synchronization signal) and PBCH (physical broadcast channel))
TDM: time division multiplexing
TRP: transmission and reception point

TRS: tracking reference signal
Ix: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

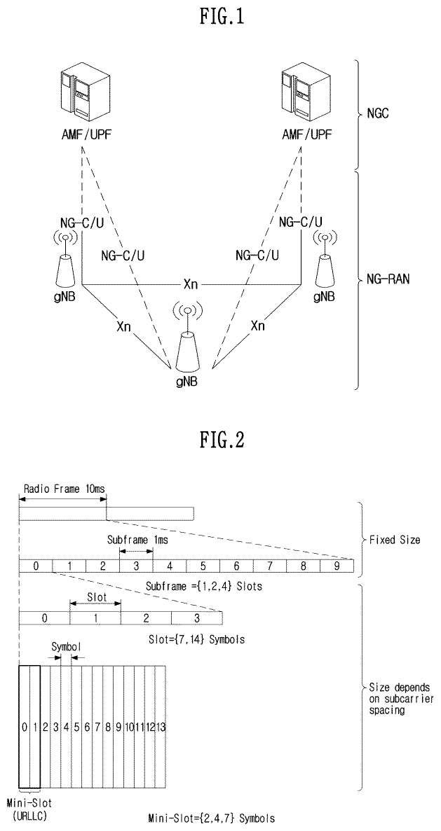

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, μ). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, |
| | | Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency | Corresponding | |
|---|---|---|
| Range | frequency | Subcarrier |
| designation | range | Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480.103 Hz and N_{f}is 4096. Downlink and uplink transmission is configured (organized) with a radio frame having a duration of T_{f}=1/(ΔfₘₐₓN_{f}/100). T_{c}=10 ms. Here, a radio frame is configured with 10 subframes having a duration of T_{sf}=(ΔfₘₐₓN_{f}/1000). T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{frame,μ-1}} in a radio frame. One slot is configured with N_{symb}^{slot} consecutive OFDM symbols and N_{symb}^{slot} is determined according to CP. A start of a slot nsu in a subframe is temporally arranged with a start of an OFDM symbol ns N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 is an example on μ=2 (SCS is 60 kHz), 1 subframe may include 4 slots referring to Table 3. 1 subframe= {1, 2, 4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail. First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship.

In this case, the large-scale property includes at least one of delay spread, doppler spread, frequency shift, average received power, received timing.

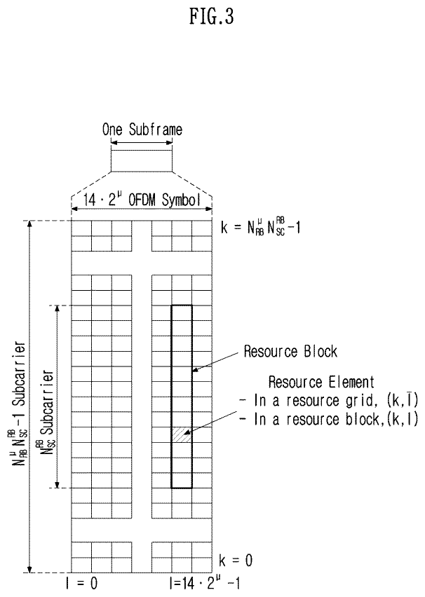

FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for μ and an antenna port p corresponds to a complex value, a_{k,l′}^{(p, μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absolute FrequencyPointA represents a frequency-position of point A expressed as in ARFCN (absolute radio-frequency channel number). Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ}and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

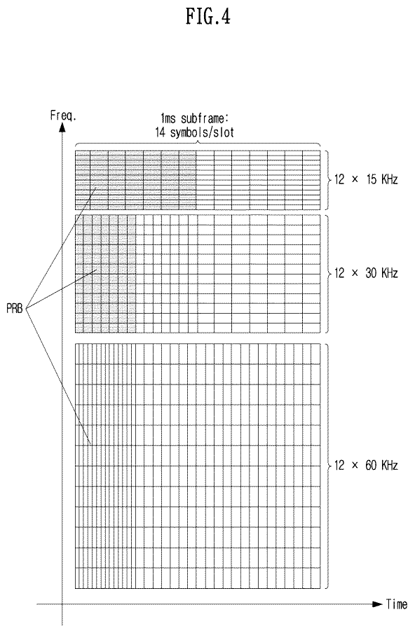

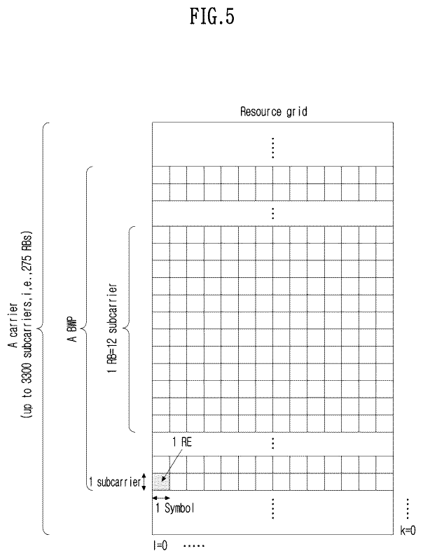

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHZ may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.).

Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

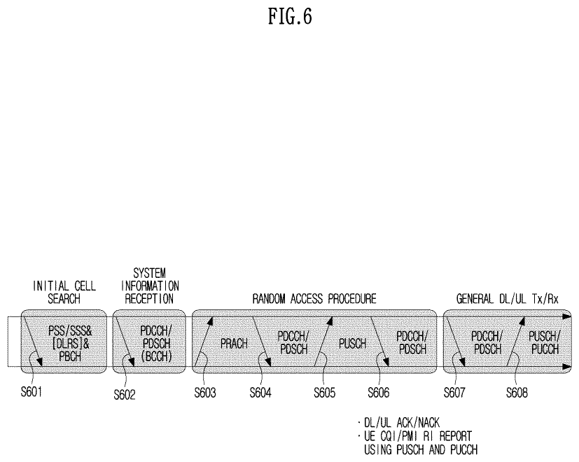

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one cell, or |
| | indication of cell group downlink feedback information to |
| | a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined.

DCI format 0_0 is used for scheduling of a PUSCH in one cell. Information included in DCI format 0_0 is CRC (cyclic redundancy check) scrambled by a C-RNTI(Cell Radio Network Temporary Identifier) or a CS-RNTI (Configured Scheduling RNTI) or a MCS-C-RNTI(Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block(TB) (e.g., MCS, NDI, RV, etc.), information related to a HARQ (e.g., a process number, DAI, PDSCH-HARQ feedback timing, etc.), information related to multiple antennas (e.g., an antenna port, a TCI(transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Wireless Communication System Supporting Unlicensed Band/Shared Spectrum

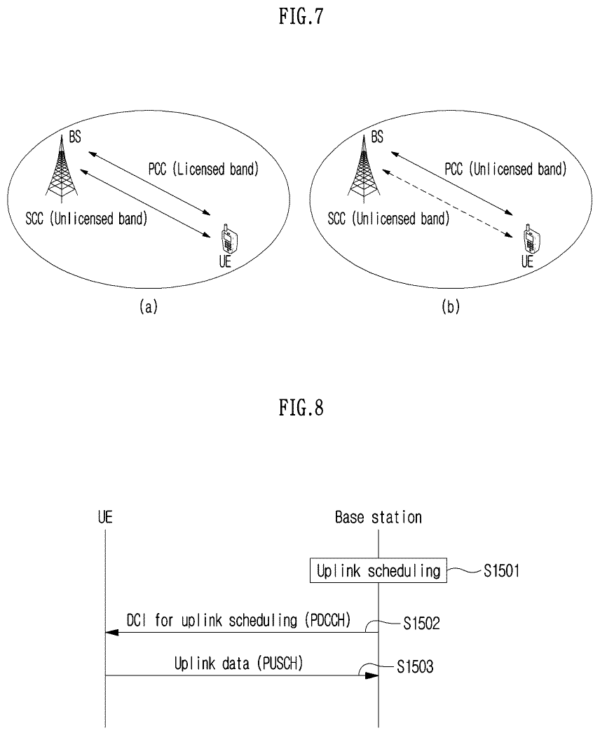

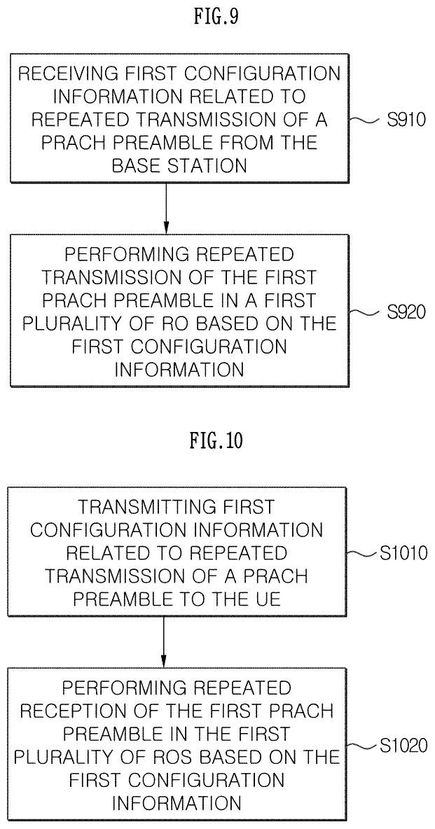

FIG. 7 shows an example of a wireless communication system supporting an unlicensed band applicable to the present disclosure. For example, FIG. 9 illustrates an unlicensed spectrum (NR-U) wireless communication system.

In the following description, a cell operating in a licensed-band (L-band) is defined as an LCell, and a carrier of the LCell is defined as a (downlink/uplink) LCC. In addition, a cell operating in an unlicensed band (U-band) is defined as a UCell, and a carrier of the UCell is defined as a (downlink/uplink) UCC. The carrier/carrier-frequency of a cell may mean an operating frequency (e.g., center frequency) of the cell. A cell/carrier (e.g., a component carrier (CC)) is collectively referred to as a cell.

As shown in (a) of FIG. 7, when a terminal and a base station transmit and receive signals through carrier aggregation (CA) LCC and UCC, the LCC may be configured as a primary CC (PCC) and the UCC may be configured as a secondary CC (SCC). And, as shown in (b) of FIG. 7, the terminal and the base station may transmit and receive signals through one UCC or a plurality of UCCs combined with carriers. That is, the terminal and the base station may transmit and receive signals only through UCC(s) without LCC. For standalone operation, PRACH, PUCCH, PUSCH, SRS transmission, etc. may be supported in UCell.

For example, the unlicensed band may be included in a specific frequency range (e.g., from 52.6 GHz to 71 GHZ) higher than the existing frequency range (e.g., FR1 and FR2). The specific frequency range may be referred to as FR2-2 (in this case, the existing FR2 (i.e., 24250 MHz-52600 MHZ) may be referred to as FR2-1) or may be referred to as FR3. The scope of this disclosure is not limited to the designations FR2-2 or FR3.

### Uplink Transmission and Reception Operation

FIG. 8 is a diagram illustrating an uplink transmission and reception operation in a wireless communication system to which the present disclosure can be applied.

Referring to FIG. 8, a base station schedules uplink transmission such as a frequency/time resource, a transport layer, an uplink precoder, an MCS, etc. (S1501). In particular, a base station can determine a beam for PUSCH transmission to a UE through the operations described above.

A UE receives DCI for uplink scheduling (i.e., including scheduling information of a PUSCH) from a base station on a PDCCH (S1502).

DCI format 0_0, 0_1, or 0_2 may be used for uplink scheduling, and in particular, DCI format 0_1 includes the following information: an identifier for a DCI format, a UL/SUL (supplementary uplink) indicator, a bandwidth part indicator, a frequency domain resource assignment, a time domain resource assignment, a frequency hopping flag, a modulation and coding scheme (MCS), an SRS resource indicator (SRI), precoding information and number of layers, antenna port(s), an SRS request, a DMRS sequence initialization, a UL-SCH (Uplink Shared Channel) indicator

In particular, SRS resources configured in an SRS resource set associated with the higher upper layer parameter ‘usage’ may be indicated by an SRS resource indicator field. Additionally, the ‘spatialRelationInfo’ can be configured for each SRS resource, and its value can be one of {CRI, SSB, SRI}.

A UE transmits uplink data to a base station on a PUSCH (S1503).

When a UE detects a PDCCH including DCI formats 0_0, 0_1, and 0_2, it transmits a PUSCH according to indications by corresponding DCI.

Two transmission methods are supported for PUSCH transmission: codebook-based transmission and non-codebook-based transmission:
i) When the higher layer parameter ‘txConfig’ is set to ‘codebook’, a UE is configured to codebook-based transmission. On the other hand, when the higher layer parameter ‘txConfig’ is set to ‘nonCodebook’, a UE is configured to non-codebook based transmission. If the up higher per layer parameter ‘txConfig’ is not set, a UE does not expect to be scheduled by DCI format 0_1. When a PUSCH is scheduled by DCI format 0_0, PUSCH transmission is based on a single antenna port.

For codebook-based transmission, a PUSCH may be scheduled in DCI format 0_0, DCI format 0_1, DCI format 0_2, or semi-statically. If this PUSCH is scheduled by DCI format 0_1, a UE determines a PUSCH transmission precoder based on an SRI, a TPMI (Transmit Precoding Matrix Indicator), and a transmission rank from DCI, as given by an SRS resource indicator field and a precoding information and number of layers field. A TPMI is used to indicate a precoder to be applied across antenna ports, and corresponds to an SRS resource selected by an SRI when multiple SRS resources are configured. Alternatively, if a single SRS resource is configured, a TPMI is used to indicate a precoder to be applied across antenna ports and corresponds to that single SRS resource. A transmission precoder is selected from an uplink codebook having the same number of antenna ports as the higher layer parameter ‘nrofSRS-Ports’. When a UE is configured with the higher layer parameter ‘txConfig’ set to ‘codebook’, the UE is configured with at least one SRS resource. An SRI indicated in slot n is associated with the most recent transmission of an SRS resource identified by the SRI, where the SRS resource precedes a PDCCH carrying the SRI (i.e., slot n).
ii) For non-codebook based transmission, a PUSCH may be scheduled in DCI format 0_0, DCI format 0_1, or semi-statically. When multiple SRS resources are configured, a UE can determine a PUSCH precoder and a transmission rank based on a wideband SRI, where, the SRI is given by an SRS resource indicator in DCI or by the higher layer parameter ‘srs-ResourceIndicator’

A UE uses one or multiple SRS resources for SRS transmission, where the number of SRS resources can be configured for simultaneous transmission within the same RB based on a UE capability. Only one SRS port is configured for each SRS resource. Only one SRS resource can be configured with the higher layer parameter ‘usage’ set to ‘nonCodebook’. The maximum number of SRS resources that can be configured for non-codebook based uplink transmission is 4. An SRI indicated in slot n is associated with the most recent transmission of an SRS resource identified by the SRI, where the SRS transmission precedes a PDCCH carrying the SRI (i.e., slot n).

### PRACH Repetition Transmission and Transmission Power Configuration Method

In order to improve UL coverage of a basic wireless communication system, a PRACH preamble repetition transmission operation may be performed. When a UE repeatedly transmits a PRACH preamble, a beam operation and/or a power control method should be defined. Hereinafter, a method for configuring/controlling transmission power when a UE performs PRACH preamble repetition transmission (or/and Msg. 3 PUSCH repetition transmission) according to an embodiment of the present disclosure will be described.

The present disclosure may be applied in combination with the above-described contents (e.g., NR frame structure, RACH procedure, U-band system, etc.). In addition, the methods related to configuring PRACH transmission occasions to be described later may be equally applied to an uplink signal transmission and reception method.

For example, uplink transmission through methods related to PRACH transmission opportunity configuration described later may be performed in an L-cell and/or U-cell defined in an NR system or a U-Band system.

FIG. 9 is a diagram for describing an uplink transmission operation of a UE in a wireless communication system to which the present disclosure may be applied.

The UE may receive first configuration information related to repeated transmission of a PRACH preamble from the base station (S910).

For example, the first configuration information may include information indicating/configuring to perform PRACH preamble repetition transmission, information related to the (maximum) number of PRACH preamble repetition transmissions, information related to the power of PRACH preamble transmission, information about at least one RO/SSB through which the PRACH preamble is transmitted, etc.

The first configuration information may be transmitted from the base station to the UE via at least one of higher layer signaling (e.g., RRC message, SIB), MAC CE, or DCI.

The UE may perform repeated transmission of the first PRACH preamble in a first plurality of RO (radon access channel occasions) based on the first configuration information (S920).

Specifically, the UE may select a most preferred SSB among a plurality of SSBs transmitted from the base station, and select a first plurality of ROs among the RO(s) mapped to the selected SSB. The UE may perform a first PRACH preamble repetition transmission across the first plurality of ROs based on the first configuration information.

And, the power of the repeated transmission of the first PRACH preamble performed across the first plurality of ROs may be based on a first reference signal (RS) for obtaining a path-loss value.

That is, within the first plurality of ROs (i.e., the first RACH attempts) in which the repeated transmission of the first PRACH preamble is performed, the same first reference signal may be set to obtain the path-loss value. That is, the UE may maintain the first reference signal for calculating the path-loss value while performing the first PRACH preamble repetition transmission.

And, the UE may determine the power of the repeated transmission of the first PRACH preamble performed in the first plurality of ROs based on the first path-loss value obtained through the first reference signal.

As an example of the present disclosure, after the repeated transmission of the first PRACH preamble is completed, within the second plurality of ROs (i.e., the second RACH attempt) selected by the UE, the UE may determine the power of repeated transmission of the second PRACH preamble performed in the second plurality of ROs based on the second path-loss value obtained through the second reference signal.

That is, the UE may configure a new reference signal (i.e., a second reference signal) for calculating the path-loss value in the second RACH attempt after the first RACH attempt is terminated. Then, the UE may determine the power of the repeated transmission of the second PRACH preamble performed in the second plurality of ROs based on the second path-loss value by using the new reference signal.

As an example of the present disclosure, transmission power ramping may not be applied within the first plurality of ROs (i.e., within the first RACH attempt). That is, the counter value for preamble power ramping may be maintained at the same value within the first plurality of ROs where the first PRACH preamble repetition transmission is performed.

Additionally or alternatively, a counter value related to the number of preamble transmissions within the first plurality of ROs in which the repeated transmission of the first PRACH preamble is performed may be maintained at the same value.

In another example of the present disclosure, based on the repeated transmission of the first PRACH preamble being stopped, within the third plurality of ROs selected by the UE after the first plurality of ROs, the UE may determine the power of the repeated transmission of the third PRACH preamble performed in the third plurality of ROs based on the third path-loss value obtained through the third reference signal.

Here, whether to allow the stop of the repeated transmission of the first PRACH preamble may be configured by the base station. For example, the UE may receive second configuration information from the base station that configures whether to allow the stop of the transmission of the first PRACH preamble.

As another example, the UE may transmit capability information to the base station regarding whether it supports allowing the stop of the repeated transmission of the first PRACH preamble. Based on the capability information transmitted by the UE to the base station, it may be determined whether the stop of the repeated transmission of the first PRACH preamble is allowed.

For example, if the capability information indicates that the UE supports allowing the stop of repeated transmission of the first PRACH preamble, repeated transmission of the first PRACH preamble may be allowed.

As another example, based on the PDCCH order indicating contention-free random access (CFRA), the stop of the repeated transmission of the first PRACH preamble may not be permitted.

FIG. 10 is a diagram for describing an uplink reception operation of a base station in a wireless communication system to which the present disclosure may be applied.

The base station may transmit first configuration information related to repeated transmission of a PRACH preamble to the UE (S1010).

For example, the base station may transmit to the UE the first configuration information including information on whether to perform PRACH preamble repetition transmission, the maximum number of PRACH preamble repetition transmissions, information related to the power of the PRACH preamble transmission, information on at least one RO/SSB in which the p PRACH preamble is transmitted.

The base station may perform repeated reception of the first PRACH preamble in the first plurality of ROs based on the first configuration information (S1020).

For example, the base station may transmit at least one reference signal for calculating path loss to the UE. A first reference signal among at least one reference signal within the first plurality of ROs may be configured/determined for calculating path loss. That is, within the first plurality of ROs, the reference signal for calculating path loss may be maintained as the first reference signal.

Hereinafter, a method for repeating PRACH transmission and a method for controlling/setting transmission power for improving coverage of a wireless communication system are specifically described.

### Embodiment 1

Embodiment 1 relates to a method for setting transmission (Tx) power during repeated transmission of a PRACH preamble.

When a UE is configured/indicated to repeatedly transmit a PRACH preamble and starts to repeatedly transmit the PRACH preamble from the configured/indicated RO, the Tx beam direction of the repeatedly transmitted PRACH preamble(s) may be configured/indicated/defined to be the same.

However, with respect to the Tx power between PRACH preamble(s) (regardless of whether the Tx beam direction of the repeatedly transmitted PRACH preamble(s) is the same), when the UE repeatedly transmits the PRACH preamble over multiple ROs (RACH occasions), the Tx between the repeatedly power transmitted RPACH preamble(s) may be configured/indicated/defined to be maintained at the same value.

For example, the UE may be configured/indicated to apply a preamble power ramping counter (PREAMBLE_POWER_RAMPING_COUNTER) of the same value to multiple RO(s) containing repeatedly transmitted PRACH preambles.

That is, the UE may be configured to maintain the PREAMBLE_POWER_RAMPING_COUNTER at the same value without increasing it during PRACH preamble repetitive transmissions (before a specific repetitive transmission ends). Additionally, the UE may be configured to maintain the PREAMBLE_TRANSMISSION_COUNTER at the same value without increasing it during PRACH preamble repetitive transmissions (before a specific repetitive transmission ends).

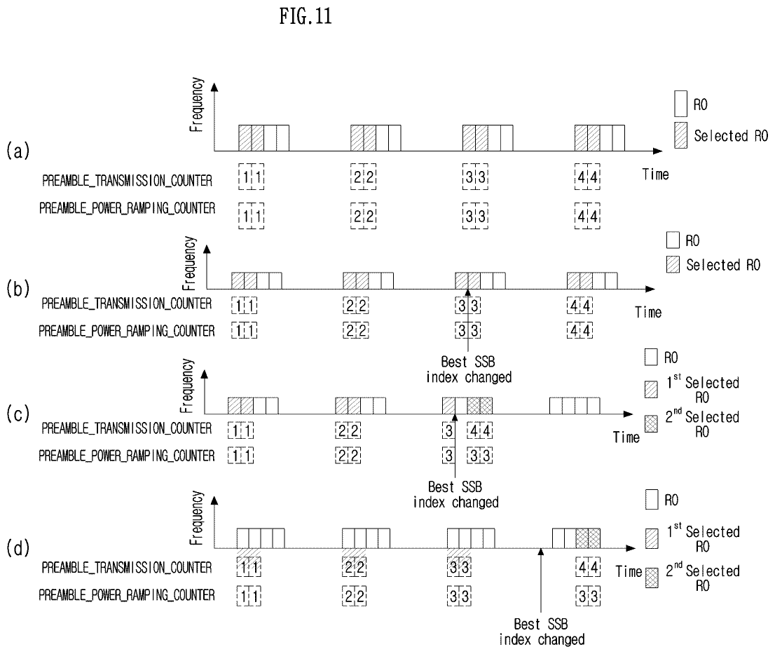

The above-described method may be implemented as in (a) of FIG. 11. As an example, as illustrated in (a) of FIG. 11, it is assumed that the base station sets the terminal to perform PRACH preamble repetition transmission a total of two times and PRACH preamble retransmission a total of four times. The UE may transmit the PRACH preamble a total of four times (including three retransmissions due to failure to receive a random access response (RAR) in the middle). Accordingly, the UE may perform repetition transmission and retransmission by selecting an RO as illustrated in (a) of FIG. 11.

### Embodiment 2

Embodiment 2 relates to the operation of a UE/base station when the SSB index most preferred by the UE changes during repeated transmission of a PRACH preamble.

The UE may select multiple ROs to repeatedly transmit the PRACH preamble. The UE may select multiple ROs mapped to the SSB index with the best reception performance from the UE's perspective (i.e., the SSB index most preferred by the UE).

Here, while the UE performs repeated PRACH preamble transmission using multiple ROs selected from among the RO(s) mapped to the SSB index that the UE initially preferred the most, the SSB index that the UE prefers the most may be changed. As described above, if the SSB index most preferred by

the UE changes during the PRACH preamble repetition transmission, it may not be good from the perspective of terminal/base station implementation and system complexity for the terminal to re-select a new RO and perform PRACH preamble repetition transmission.

### Embodiment 2-1

Even if the SSB index most preferred by the UE changes during the PRACH preamble repetition transmission, the UE may be configured not to re-select a new RO and perform retransmission. That is, even if the SSB index most preferred by the UE changes during the PRACH preamble repetition transmission, the UE may perform PRACH preamble repetition transmission using previously selected ROs without performing RO re-selection.

The above-described method may be implemented as in (b) of FIG. 11. For example, as shown in (b) of FIG. 11, it is assumed that the base station configures the UE to perform PRACH preamble repetition transmission a total of two times and PRACH preamble retransmission a total of four times. If the UE is not allowed to select a new RO even if the most preferred SSB index changes during the PRACH preamble repetition transmission, the UE may transmit the PRACH preamble a total of four times (including three retransmissions due to failure to receive a random access response (RAR) in the middle). Accordingly, as shown in (b) of FIG. 11, the UE may perform PRACH preamble repetition transmission and retransmission by selecting an RO.

### Embodiment 2-2

If the SSB index most preferred by the UE changes during the PRACH preamble repetition transmission, the UE may be configured/defined to stop the PRACH preamble repetition transmission instead of continuing it.

As another example, the base station may be configured to allow the UE to stop PRACH preamble repetition transmission (when the most preferred SSB index of the UE changes). As an example, the base station may transmit/provide to the UE a parameter that indicates/configures whether PRACH preamble repetition transmission can be stopped or not via higher layer signaling (e.g., RRC message, SIB (system information block), etc.).

Additionally or alternatively, if the parameter indicating/configuring whether PRACH preamble repetition transmission can be stopped is not transmitted/provided to the UE, the UE may be set to understand that PRACH preamble repetition transmission can be stopped (or not) by default.

For example, assume that the base station configures/indicates the UE to be able to stop PRACH preamble repetition transmission (or, the UE is allowed to stop PRACH preamble repetition transmission). If a most preferred SSB index is changed in the middle of PRACH preamble repetition transmission, the UE may stop the existing PRACH preamble repetition transmission (or/and the UE does not expect to receive RAR for the existing PRACH preamble repetition transmission). Then, the UE may be configured to proceed with the RACH procedure by newly selecting a plurality of ROs mapped to the newly selected SSB index after a (predefined/instructed) processing time required for selecting a new RO and/or beam switching, etc. has elapsed.

Additionally or alternatively, even if the repeated transmission of the existing PRACH preamble is stopped, the UE may be configured to expect reception of an RAR for the previously transmitted PRACH preamble. In this case, if the UE receives an RAR for the previously transmitted PRACH preamble, the UE may perform Msg. 3 PUSCH transmission based on the RAR. If the UE does not receive an RAR for the previously transmitted PRACH preamble, the UE may be configured to select a new RO according to a newly selected SSB index.

Additionally or alternatively, the UE may be configured/indicated/defined to stop repeating PRACH preamble transmission only when the beam direction of the newly selected SSB index is different from the beam direction of the previously selected SSB index.

Here, if a new PRACH preamble repetition transmission is started in newly selected ROs, power ramping (compared to existing repetition transmission) may not be allowed. That is, if a new PRACH preamble repetition transmission is started in newly selected ROS, PREAMBLE_POWER RAMPING_COUNTER may be configured/defined not to increase. In addition, if a UE starts a new PRACH preamble repetition transmission after stopping performing PRACH preamble repetition transmission, PREAMBLE_TRANSMISSION_COUNTER may be configured/defined to increase.

The above-described method can be implemented as in (c) of FIG. 11. As an example, as shown in (c) of FIG. 11, it is assumed that the base station configures the UE to be able to perform PRACH preamble repetition transmission a total of two times and PRACH preamble retransmission a total of four times. If the most preferred SSB index is changed during the PRACH preamble repetition transmission, the UE may be configured to stop the existing PRACH preamble repetition transmission and re-select a new RO to proceed with the RACH procedure.

For example, if the UE determines that the most preferred SSB index has changed at the second retransmission time point (the third transmission time point in total including the initial transmission), the UE may immediately stop the existing PRACH preamble repetition transmission, select a new RO, and proceed with the RACH procedure.

Here, as shown in (c) of FIG. 11, considering the case where the beam direction of the SSB index newly selected by the UE is different from the beam direction of the SSB index previously selected, PREAMBLE_TRANSMISSION_COUNTER (i.e., the PRACH preamble transmission related counter) may increase, but PREAMBLE_POWER_RAMPING_COUNTER may not increase.

Accordingly, when the PREAMBLE_TRANSMISSION_COUNTER while performing the existing PRACH preamble repeat transmission is equal to the maximum number of PRACH preamble transmissions (e.g., the ‘preambleTransMax’ value), the UE may be configured/defined not to stop the existing PRACH preamble repeat transmission (i.e., configured/defined not to allow the PRACH preamble repeat transmission to be stopped).

Here, if the PREAMBLE_TRANSMISSION_COUNTER is equal to the ‘preambleTransMax’ value when performing the existing PRACH preamble repeat transmission, it means that the UE stops the PRACH preamble repeat transmission and tries to perform a new repeat transmission, but when the PREAMBLE_TRANSMISSION_COUNTER value is increased by 1, the PREAMBLE_TRANSMISSION_COUNTER value becomes larger than ‘preambleTransMax’, so the new PRACH preamble repeat transmission cannot be performed. That is, since the PRAEMBLE_TRANSMISSION_COUNTER value becomes ‘preambleTransMax+1’, the UE may not be able to perform a new PRACH preamble repeat transmission.

### Embodiment 2-3

If the base station configures/indicates that PRACH preamble repetition transmission interruption is not possible (or, PRACH preamble repetition transmission interruption is not allowed), the UE may be configured/indicated to proceed with the existing PRACH preamble repetition transmission even if the most preferred SSB index changes during the PRACH preamble repetition transmission.

However, it is assumed that the SSB index preferred by the UE has changed between the time point at which the existing PRACH preamble repetition transmission is completed and the time point at which the retransmission starts (when the UE expects to receive RAR but fails to receive it). In this case, the UE may select multiple ROs among the ROs mapped to the newly selected SSB index and perform retransmission for the PRACH preamble repetition transmission without power ramping (compared to the existing repetition transmission).

The above-described method can be implemented as in (d) of FIG. 11. As an example, as illustrated in (d) of FIG. 11, it is assumed that the base station configures the UE to be able to perform PRACH preamble repetition transmission a total of two times and PRACH preamble retransmission a total of four times. In addition, it is assumed that the existing PRACH preamble repetition transmission is not allowed to be stopped even if the most preferred SSB index is changed in the middle of the PRACH preamble repetition transmission. If the time at which the most preferred SSB index of the UE is changed is within a specific time, the UE may select ROs mapped to the new index before the third retransmission (the fourth transmission if including the initial transmission) and proceed with the RACH procedure.

Here, a specific point in time may mean a time period from the time a particular iterative transmission ends until the next iterative transmission begins (and/or including the RO selection time).

For example, referring to (d) of FIG. 11, considering a case where the newly selected SSB index and the previously selected SSB index are different, the value related to PREAMBLE_TRANSMISSION_COUNTER may increase, but the value related to PREAMBLE_POWER_RAMPING_COUNTER may not increase.

### Embodiment 2-4

In the above-described embodiments, when the UE changes the beam by retransmitting the PRACH preamble regardless of whether the PRACH preamble repetition transmission is stopped, the value related to PREAMBLE_TRANSMISSION_COUNTER increases, and the value related to PREAMBLE_POWER RAMPING_COUNTER does not increase.

In a basic wireless communication system, a single PRACH preamble is transmitted, but the present disclosure describes an embodiment in which a PRACH preamble is repeatedly transmitted. Accordingly, when a UE changes a PRACH transmission beam, the UE may initialize

PREAMBLE_TRANSMISSION_COUNTER and/or PREAMBLE_POWER_RAMPING COUNTER to an initial set value (e.g., 1) and proceed with a RACH procedure.

That is, if the SSB-RSRP of the SSB newly selected by the UE is greater than a specific value (or, if the RSRP change amount is greater than the threshold value when the base station provides a threshold value for RSRP change amount to the UE), PREAMBLE_TRANSMISSION_COUNTER and/or PREAMBLE POWER RAMPING_COUNTER may be reset.

As another example, if the SSB-RSRP of the newly selected SSB is below a specific value (or, if the RSRP change amount is within a threshold provided by the base station), the PREAMBLE_TRANSMISSION_COUNTER and/or PREAMBLE_POWER_RAMPING COUNTER values may be set to be maintained.

### Embodiment 2-5

The allowance of stopping of PRACH preamble repetitive transmission may be set to be determined in advance according to a specific service scenario. For example, in a terrestrial network (TN) such as NR or/and LTE where the round trip delay is not large, stopping of PRACH preamble repetitive transmission may be set not to be allowed. In addition, in a situation such as a non-terrestrial network (NTN) and/or air-to-ground (ATG) where the round trip delay is large, interruption of PRACH preamble repetitive transmission may be set to be allowed.

Here, if it is confirmed that the current service is a TN service through higher signaling (e.g., RRC message, SIB, etc.), the UE may determine that the stopping of repeated transmission of PRACH preamble is not permitted.

As another example, if it is confirmed (via higher layer signaling) that the current service is an NIN service, the UE may determine that stopping the repeated transmission of the PRACH preamble is allowed.

Alternatively, capability for whether PRACH preamble repeat transmission can be stopped may be introduced. Depending on the UE capability of the UE (i.e., depending on the capability information related to whether PRACH preamble repeat transmission can be stopped transmitted by the terminal to the base station), stopping of PRACH preamble repeat transmission may or may not be allowed.

Additionally or alternatively, if CFRA (Contention-free Random Access) is indicated by the PDCCH order, whether to allow PRACH preamble repetitive transmission suspension may be indicated to the terminal through the DCI (i.e., PDCCH) in which the PDCCH order is transmitted. Here, the UE may determine whether to allow PRACH preamble repetitive transmission suspension through the DCI in which the PDCCH order is transmitted.

Additionally or alternatively, it may be configured/defined whether to stop PRACH preamble repetition transmission depending on the RA type (i.e., Contention-based Random Access (CBRA) and CFRA).

That is, when CFRA is indicated by the PDCCH order, the base station may select the RO corresponding to the best UL beam for the corresponding UE. Accordingly, when CFRA is indicated by the PDCCH order, it may be set so that the stopping of repeated transmission of the PRACH preamble is not allowed.

The SSB used in the embodiments described above may be replaced with other types of reference signals and/or CSI-RS, etc. That is, other types of reference signals and/or CSI-RS, etc. may be applied to the embodiments described above.

Also, the best UL index may be considered together with (or instead of) the best SSB index among the embodiments described above, the best UL index may be based on the operation of selecting either NUL or SUL.

In addition, the above-described embodiments describe a case where a terminal changes an SSB index when there is a better SSB index regardless of the RSRP value of the existing SSB index.

As another example, the terminal may be configured/defined to select the best SSB index only when the RSRP of the currently selected SSB index falls below a specific threshold value that is configured/indicated in advance.

### Embodiment 3

Embodiment 3 relates to a method for setting a reference signal for calculating path-loss during repeated transmission of a PRACH preamble.

For example, assuming that the UE performs PRACH preamble repetition transmission using ROs (selected by the terminal) among ROs mapped to the most preferred SSB index at first, the UE's most preferred SSB index is changed but the existing PRACH preamble repetition transmission continues. In this case, if the operation according to the basic wireless communication system is performed, the path-loss value may change in terms of UL Tx power control.

As described above, there is a problem that the UL Tx power calculated based on the path-loss value may change during the PRACH preamble repetition transmission when the path-loss value changes.

Therefore, when the SSB index most preferred by the terminal is changed while performing PRACH preamble repetition transmission, if the existing PRACH preamble repetition transmission is continued, the UE may maintain the reference signal for path loss calculation as the same. And, the UE may apply the calculated path loss value to the power control operation at the time of receiving the path loss measurement reference signal.

Additionally or alternatively, while performing PRACH preamble repeat transmission, assume that the UE stops the existing PRACH preamble repeat transmission (in a situation where the repeat transmission stop is allowed) when the UE's most preferred SSB index is changed. Here, if the UE is to perform a new repeat transmission by selecting multiple ROs corresponding to the new SSB index, the UE may be configured to change the reference signal for path-loss calculation based on the new SSB index.

The above-described embodiments can be set/applied to other UL signals/channels such as Msg. 3 PUSCH, MSGA preamble/PUSCH and/or PUSCH/PUCCH. That is, in the above-described embodiments, the ‘PRACH preamble’ can be replaced with other UL signals/channels such as Msg. 3 PUSCH, MSGA preamble/PUSCH and/or PUSCH/PUCCH. In addition, it is obvious that the above-described embodiments can also be included as one of the implementation methods of the present disclosure, and thus can be considered as a kind of embodiments.

In addition, the above-described embodiments may be implemented independently, but may also be implemented in the form of a combination (or merge) of some embodiments. Information on whether the above-described embodiments are applicable (or information on rules of the embodiments) may be defined so that a rule is defined so that the base station notifies the UE through a predefined signal (e.g., a physical layer signal or a higher layer signal). The higher layer may include, for example, one or more of functional layers such as MAC, RLC, PDCP, RRC, and SDAP.

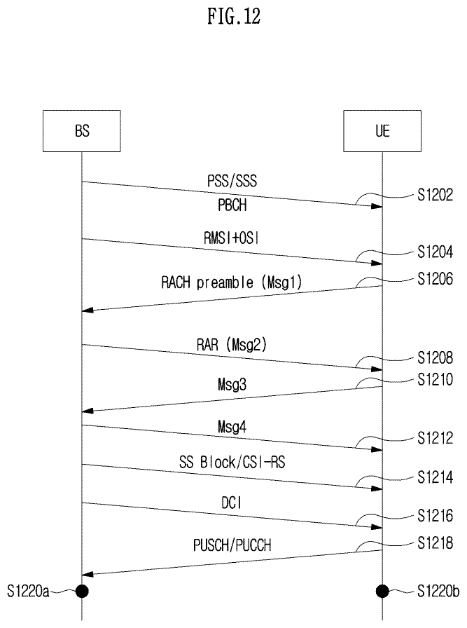

FIG. 12 is a diagram for describing a signaling procedure of a network side and a terminal according to one embodiment of the present disclosure.

FIG. 12 shows an example of signaling between a network side and a terminal (UE) in an M-TRP situation to which the embodiments of the above-described disclosure (e.g., one or more combinations of Embodiment 1, Embodiment 2, Embodiment 2-1, Embodiment 2-2, Embodiment 2-3, Embodiment 2-4, Embodiment 2-5, Embodiment 3 or detailed examples thereof) may be applied.

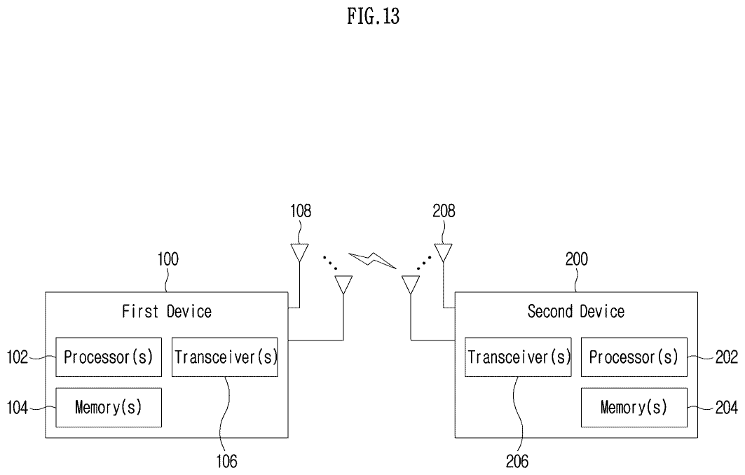

Here, the UE/network side is an example and may be replaced with various devices as described with reference to FIG. 13. FIG. 12 is for convenience of explanation and does not limit the scope of the present disclosure. Additionally, some step(s) shown in FIG. 12 may be omitted depending on the situation and/or settings. Additionally, in the operation of the network side/UE in FIG. 12, the above-described uplink transmission/reception operation, M-TRP-related operation, etc. may be referenced or used.

In the following description, the network side may be one base station including multiple TRPs, or may be one cell including multiple TRPs. Alternatively, the network side may include a plurality of remote radio heads (RRH)/remote radio units (RRU). For example, ideal/non-ideal backhaul may be set between TRP 1 and TRP 2, which constitute the network side. In addition, the following description is based on multiple TRPs, but it can be equally extended and applied to transmission through multiple panels/cells, and can also be extended and applied to transmission through multiple RRHs/RRUs, etc.

In addition, it is described based on a “TRP” in the following description, but as described above, a “TRP” may be applied by being substituted with an expression such as a panel, an antenna array, a cell (e.g., a macro cell/a small cell/a pico cell, etc.), a TP (transmission point), a base station (gNB, etc.), etc. As described above, a TRP may be classified according to information on a CORESET group (or a CORESET pool) (e.g., a CORESET index, an ID).

For example, if a single UE is configured to transmit and receive with multiple TRPs (or cells), this may mean that multiple CORESET groups (or CORESET pools) are configured for the single terminal. The configuration of such CORESET groups (or CORESET pools) may be performed via higher layer signaling (e.g., RRC signaling, etc.).

In addition, a base station may generally mean an object performs transmission and reception of data with a terminal. For example, the base station may be a concept which includes at least one TP (Transmission Point), at least one TRP (Transmission and Reception Point), etc. In addition, a TP and/or a TRP may include a panel, a transmission and reception unit, etc. of a base station.

Referring to FIG. 13, a base station (e.g., BS) may periodically transmit SSB to a terminal (S1202). Here, the SSB may include PSS/SSS/PBCH. The base station may transmit SSB to a UE using beam sweeping.

The base station may transmit remaining minimum system information (RMSI) and other system information (OSI) to the terminal (S1204). RMSI may include information required for the terminal to initially access the base station (e.g., PRACH configuration information). Here, the UE may identify the best SSB after performing SSB detection.

Thereafter, the UE may transmit a RACH preamble (Message 1, Msg1) to the base station using the PRACH resource linked/corresponding to the index (i.e., beam) of the best SSB (S1206).

The beam direction of the RACH preamble may be associated with a PRACH resource. The association between the PRACH resource (and/or the RACH preamble) and the SSB index can be established via system information (e.g., RMSI).

Here, the UE may perform PRACH preamble repetition transmission. The UE may perform PRACH preamble repetition transmission based on configuration information related to PRACH repetition transmission received from the base station.

Thereafter, as part of the RACH process, the base station may transmit a Random Access Response (RAR) (Msg2) to the terminal in response to the PRACH preamble (S1208).

The RAR may include at least one of a field related to PUSCH repeated transmission, a field for indicating whether to repeat PUSCH preamble transmission, or a PUSCH time/frequency resource field.

The UE may transmit Msg. 3 PUSCH (e.g., RRC Connection Request) using the uplink grant in the RAR (S1210).

The UE may perform PUSCH repeated transmission based on RAR. Here, the number of PUSCH repeated transmissions may be based on the number of PRACH preamble repeated transmissions.

The base station may transmit a contention resolution message (Msg4) to the terminal (S1212). Msg4 may include RRC connection setup.

When an RRC connection is established between a base station and a UE through the RACH process, subsequent beam alignment may be performed based on SSB/CSI-RS (in downlink) and SRS (in uplink). For example, the UE may receive SSB/CSI-RS (S1214). SSB/CSI-RS may be used by the UE to generate beam/CSI report.

And, the base station may request the UE to report beam/CSI through DCI (S1216). Here, the UE may generate the beam/CSI report based on SSB/CSI-RS and transmit the generated beam/CSI report to the base station through PUSCH/PUCCH (S1218). The beam/CSI report may include beam measurement results, information about preferred beams, etc. The base station and the UE may switch beams based on the beam/CSI report (S1220a, S1220b).

Thereafter, the UE and the base station may perform the embodiments described/proposed above. For example, the UE and the base station may process information in the memory and transmit a wireless signal or process a received wireless signal and store it in the memory based on the configuration information obtained in the network access procedure (e.g., system information acquisition n procedure, RRC connection procedure via RACH, etc.) according to the embodiment of the present disclosure. Here, the wireless signal may include at least one of PDCCH, PDSCH, and RS (Reference Signal) in the case of downlink, and at least one of PUCCH, PUSCH, and SRS in the case of uplink.

### General Device to which the Present Disclosure may be Applied

FIG. 13 is a diagram which illustrates a block diagram of a wireless communication system according to an embodiment of the present disclosure.

In reference to FIG. 13, a first device 100 and a second device 200 may transmit and receive a wireless signal through a variety of radio access technologies (e.g., LTE, NR).

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts included in the present disclosure.

For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104.

A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts included in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts included in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts included in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts included in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206.

One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts included in the present disclosure. One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts included in the present disclosure may be implemented by using a firmware or a software and a firmware or a software may be implemented to include a module, a procedure, a function, etc. A firmware or a software configured to perform description, functions, procedures, proposals, methods and/or operation flow charts included in the present disclosure may be included in one or more processors 102, 202 or may be stored in one or more memories 104, 204 and driven by one or more processors 102, 202. Description, functions, procedures, proposals, methods and/or operation flow charts included in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. included in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. included in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a device 100, 200 of the present disclosure may include Narrowband Internet of Things for a low-power communication as well as LTE, NR and 6G. Here, for example, an NB-IOT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method comprising:
receiving, by a user equipment (UE), first configuration information related to repeated transmission of a physical random access channel (PRACH) preamble from a base station; and
performing, by the UE, repeated transmission of a first PRACH preamble in a first plurality of radon access channel occasions (RO) based on the first configuration information,
wherein a power of the repeated transmission of the first PRACH preamble performed across the first plurality of ROs is based on a first reference signal (RS) for obtaining a path-loss value, and
wherein a power ramping counter related to the repeated transmission of the first PRACH preamble is suspended, and
wherein a same spatial parameter is applied to the repeated transmission of the first PRACH preamble.

2. (canceled)

3. The method of claim 1, wherein:
based on a first path-loss value obtained through the first reference signal, the power of the repeated transmission of the first PRACH preamble performed in the first plurality of ROs is determined.

4. The method of claim 1, wherein:
after the repeated transmission of the first PRACH preamble is completed, the power of repeated transmission of a second PRACH preamble performed in a second plurality of ROs selected by the UE is determined based on a second path-loss value obtained through a second reference signal.

5. The method of claim 1, wherein:
based on the repeated transmission of the first PRACH preamble repetition being stopped, a power of repeated transmission of a third PRACH preamble performed in the third plurality of ROs is determined within a third plurality of ROs selected by the UE after the first plurality of ROs, based on A third path-loss value acquired through a third reference signal.

6. The method of claim 1, wherein:
a counter value related to a number of preamble transmissions within the first plurality of ROs where the repeated transmission of the first PRACH preamble repetition is performed is maintained at a same value.

7. The method of claim 1, wherein:
second configuration information for configuring whether to allow stopping of the repeated transmission of the first PRACH preamble repetition is received from the base station.

8. The method of claim 1, wherein:
capability information related to whether or not to support allowing stopping of the repeated transmission of the first PRACH preamble repetition is transmitted to the base station, and
whether or not to allow stopping of the repeated transmission of the first PRACH preamble is determined based on the capability information.

9. The method of claim 1, wherein:
based on a contention-free random access (CFRA) being indicated through a physical downlink control channel (PDCCH) order, stopping of the repeated transmission of the first PRACH preamble is not allowed.

10. A user equipment (UE) comprising:
at least one transceiver; and
at least one processor connected to the at least one transceiver,
wherein the at least one processor is configured to:
receive, through the at least one transceiver, first configuration information related to repeated transmission of a physical random access channel (PRACH) preamble from a base station; and
perform repeated transmission of a first PRACH preamble in a first plurality of radon access channel occasions (RO) based on the first configuration information,
wherein a power of the repeated transmission of the first PRACH preamble performed across the first plurality of ROs is based on a first reference signal (RS) for obtaining a path-loss value, and
wherein a power ramping counter related to the repeated transmission of the first PRACH preamble is suspended, and
wherein a same spatial parameter is applied to the repeated transmission of the first PRACH preamble.

11. (canceled)

12. A base station comprising:
at least one transceiver; and
at least one processor connected to the at least one transceiver,
wherein the at least one processor is configured to:
transmit, through the at least one transceiver, first configuration information related to repeated reception of a physical random access channel (PRACH) preamble to a user equipment (UE); and
perform repeated reception of a first PRACH preamble in a first plurality of radon access channel occasions (RO) based on the first configuration information,
wherein a power of the repeated transmission of the first PRACH preamble performed across the first plurality of ROs is based on a first reference signal (RS) for obtaining a path-loss value, and
wherein a power ramping counter related to the repeated transmission of the first PRACH preamble is suspended, and
wherein a same spatial parameter is applied to the repeated transmission of the first PRACH preamble.

13.-14. (canceled)
